(19) United States
(12) Patent Application Publication
(10) Pub. No.: US 2026/0228048 A1
(43) Pub. Date: Aug. 6, 2026

(54) METHODS FOR ALIGNMENT OF PLAN TO EXECUTION USING MULTIMODAL CUES FOR SCRIPT-BASED PERFORMANCE MONITORING

(71) Applicant: DISNEY ENTERPRISES, INC., Burbank, CA (US)

(72) Inventors: Erick Kevin MOEN, El Segundo, CA (US); Reshmashree BANGALORE KANTHARAJU, Pasadena, CA (US); Bo DONG, Burbank, CA (US); Komath Naveen KUMAR, Los Angeles, CA (US); Douglas A. FIDALEO, Santa Clarita, CA (US); Seyun UM, Seoul (KR)

(21) Appl. No.: 19/043,297

(22) Filed: Jan. 31, 2025

(51) Int. Cl. G06F 9/50

(52) U.S. Cl. CPC G06F 9/5027

(57) ABSTRACT

The present invention sets forth techniques for aligning a performance plan to an execution of a scripted performance. The techniques include receiving a performance plan, wherein the performance plan includes one or more documents associated with a scripted performance, and identifying, via a first machine learning model and based on the one or more documents, one or more segments included in the scripted performance. The techniques also include predicting, via a second machine learning model, a current segment of the one or more segments based at least on one or more observation signals associated with an execution of the scripted performance, and initiating the execution of one or more automated actions based on the predicted current segment.

### BACKGROUND

### Field of the Various Embodiments

Embodiments of the present disclosure relate generally to script-based performance monitoring and, more specifically, to techniques for aligning a plan to an execution using multimodal cues for script-based performance monitoring.

### Description of the Related Art

Scripted performances may include, but are not limited to, live shows, presentations, film shoots, parades, or meet-and-greet events between performers and members of the public. Some performances may be intended to closely follow an associated script in a linear fashion, while other performances may incorporate nonlinear execution, such as branches or loops in the script.

It may be desirable to track or otherwise monitor the execution of a performance based on a script or other plan associated with the performance. In some instances, monitoring the performance may allow for a post-performance evaluation of how faithfully the performance adhered to the script or other plan. Monitoring a state of a performance relative to the script or other plan may also aid in manually or automatically responding to cues included in the script or other plan, such as initiating sound effects, visual effects, lighting effects, or execution of animatronic or other robotic actions.

Existing methods of scripted performance monitoring may be configured for a specific performance, and may require direct human intervention to compare a state of a performance to a predicted position within a script. These manual methods may require extensive operator training for many different performances, and do not provide a generalized solution applicable to any arbitrary scripted performance. Existing automated methods of scripted performance monitoring may be manually programmed to monitor fully automated scenarios, but may provide limited feedback to operators, as these methods may not be based on human-interpretable scripts or other plans. Further, existing methods of scripted performance monitoring may not be reactive to multimodal input describing a performance, and may not be operable to automatically actuate one or more audiovisual effects, automations or other actions based on cues included in a plan and detected during a performance.

As the foregoing illustrates, what is needed in the art are more effective techniques for aligning a plan to an execution using multimodal cues for script-based performance monitoring.

### SUMMARY

One embodiment of the present invention sets forth a technique for aligning a performance plan to an execution of a scripted performance. The technique includes receiving a performance plan, wherein the performance plan includes one or more documents associated with a scripted performance and identifying, via a first machine learning model and based on the one or more documents, one or more segments included in the scripted performance. The technique also includes predicting, via a second machine learning model, a current segment of the one or more segments based at least on one or more observation signals associated with the execution of the scripted performance, and initiating an execution of one or more automated actions based on the predicted current segment.

One technical advantage of the disclosed techniques relative to the prior art is that the disclosed techniques are operable to automatically monitor a scripted performance based on a human-interpretable script or other plan and multimodal input describing the performance. The disclosed techniques may also prompt the automatic execution of one or more automations or other actions based on a predicted state of the performance relative to the script or other plan. These technical advantages provide one or more improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present invention.

FIG. 2 is a more detailed illustration of the alignment engine of FIG. 1, according to some embodiments.

FIG. 3 is a flow diagram of method steps for performing multimodal alignment of a plan to the execution of a live performance, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

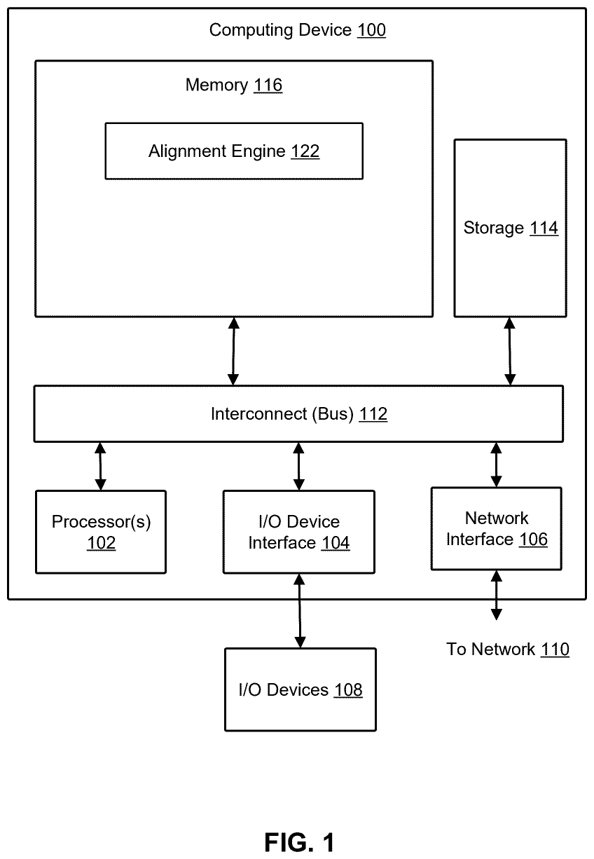

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run an alignment engine 122 that resides in a memory 116.

It is noted that the computing device described herein is illustrative and that any other technically feasible configurations fall within the scope of the present disclosure. For example, multiple instances of alignment engine 122 could execute on a set of nodes in a distributed and/or cloud computing system to implement the functionality of computing device 100. In another example, alignment engine 122 could execute on various sets of hardware, types of devices, or environments to adapt alignment engine 122 to different use cases or applications. In a third example, alignment engine 122 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Alignment engine 122 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including alignment engine 122.

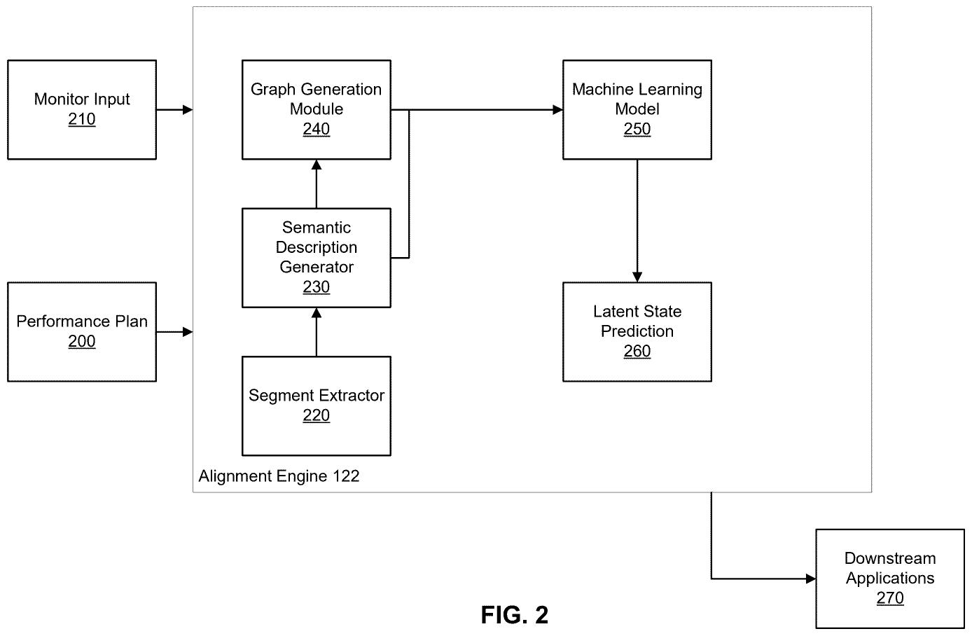

FIG. 2 is a more detailed illustration of alignment engine 122 of FIG. 1, according to some embodiments. Alignment engine 122 receives performance plan 200 associated with a scripted performance and extracts a collection of segments or beats from the performance plan. Alignment engine 122 generates a semantic description associated with each segment or beat included in performance plan 200 and generates a directed graph associated with the performance plan 200. Alignment engine 122 receives monitor input 210 including audio and/or visual signals associated with a live execution of the scripted performance. Based on performance plan 200, monitor input 210, and the semantic descriptions, alignment engine 122 predicts a current latent state included in the directed graph that corresponds to monitor input 210 at a particular temporal location within the live execution. Alignment engine 122 may transmit the predicted latent state to one or more downstream applications 270. Alignment engine 122 includes, without limitation, segment extractor 220, semantic description generator 230, graph generation module 240, machine learning model 250, and latent state prediction 260.

Performance plan 200 includes one or more descriptive documents associated with a scripted performance. The descriptive documents may include, but are not limited to, a script, a synopsis, or a cue sheet. A script may include one or more of character dialogue, scenery, location, or environment descriptions, stage directions, descriptions of character actions, descriptions of potential audience reactions, or descriptions of sound and/or visual effects. A synopsis may include a description of the scripted work, including characters, storyline, main plot points, character development, tone, genre, theme, or settings. A cue sheet may include a listing of cues within a scripted performance, such as spoken lines or character actions. Each cue may be associated with a corresponding action, such as a character action or reaction, a change in lighting, a sound effect, a visual effect, or an animatronic or robotic action.

Monitor input 210 includes one or more observation signals associated with a live execution of the scripted performance. The one or more observation signals may include, for example, audio and/or video feeds associated with the live execution. Each of the one or more observation signals may include a timestamp or other timing information indicating a relative or absolute temporal location of an observation within the live execution of the scripted performance. Monitor input 210 may include observations of, e.g., actors, audience members, scenery, or a geographical location or area associated with the live execution. In various embodiments where the scripted performance includes Augmented Reality or Virtual Reality (AR/VR) elements, monitor input 210 may include egocentric audio and/or visual content provided to one or more audience members via an AR/VR headset, glasses, or similar display device. For scripted performances that include animatronic or robotic elements, monitor input 210 may also include location and/or behavior information describing a robot or animatronic character. For example, location information may include an absolute location of a robot or animatronic character within a coordinate system, and/or a location of the robot or animatronic character relative to, e.g., a landmark, one or more different characters, or one or more audience members. Behavior information describing the robot or animatronic character may include pose or orientation information associated with one or more limbs included in the robot or animatronic character, as well as animation, speech, lighting, or sound effects performed by the robot or animatronic character.

Alignment engine 122 receives performance plan 200 and generates, via segment extractor 220, segments or beats associated with the scripted performance. In various embodiments, a segment or beat refers to a change from one scene to another, or to a change within a scene based on, for example, lighting, action, dialogue, or sound events included in the scene. Segments or beats may include, but are not limited to, a reaction by an actor, a change in trajectory associated with a character's storyline, a change in tone or mood within a scene, or a change in the topic of a conversation. Some scripted performances may proceed in a linear fashion from one beat to the next, without skipping or repeating any beats. Other scripted performances may include potential deviations based on, for example, character improvisation or audience interaction. Such deviations may include loops of one or more repeating beats, or parallel branches within the scripted performance each including one or more beats. Segment extractor 220 may include a trained machine learning model that performs a semantic analysis of one or more elements included in performance plan 200 and identifies individual segments or beats associated with the scripted performance. In various embodiments, the one or more elements included in performance plan 200 may include a script, a synopsis, and/or a cue sheet. Segment extractor 220 may associate portions of the one or more elements included in performance plan 200 with each of the identified segments or beats. For example, segment extractor 220 may associate a portion of the script, a portion of the synopsis, and/or one or more entries included in the cue sheet with an identified segment or beat. Segment extractor 220 transmits the identified segments/beats and the associated portions of performance plan 200 to semantic description generator 230.

Semantic description generator 230 analyzes the portions of performance plan 200 associated with the segments or beats received from segment extractor 220 and generates, for each segment or beat, a textual description associated with the segment or beat. In various embodiments, semantic description generator 230 may include a trained machine learning model that generates a plain language summary or other description associated with a segment or beat, based on the portions of performance plan 200 associated with the segment or beat. A plain language summary may include scene descriptions, character dialogue or actions included in a script, plot points or character development points included in a synopsis, and/or cues included in a cue sheet describing sound, visual, animatronic, robotic, lighting, or other effects. Semantic description generator 230 transmits the segments/beats identified by segment extractor 220 to graph generation module 240, and transmits the textual segment or beat descriptions to machine learning model 250 discussed below.

Graph generation module 240 analyzes the segments or beats identified by segment extractor 220 and the textual descriptions associated with each beat or segment received from semantic description generator 230. Based on the analysis, graph generation module 240 produces a directed graph including one or more nodes and one or more edges, where each node is associated with a single segment or beat and each edge represents a potential transition from one node to another node, or from one node to itself. Graph generation module 240 determines the structure of the nodes and edges based on the beats and segments identified by segment extractor 220, the descriptions received from semantic description generator 230, and the elements included in performance plan 200. In various embodiments, graph generation module 240 may also associate a node included in the directed graph with a “start” label, and may associate one or more nodes included in the directed graph with an “end” label. Each node included in the directed graph represents a latent state of the scripted performance associated with a single segment or beat, and includes a semantic description associated with the segment or beat. The directed graph represents a machine-readable expression of the structure of the scripted performance, including potential paths through the scripted performance from one latent state to another. Graph generation module 240 transmits the directed graph to machine learning model 250.

Machine learning model 250 includes one or more trained machine learning models that compare features included in monitor input 210 with textual descriptions associated with nodes included in the directed graph received from graph generation module 240. Based on the comparison, machine learning model 250 predicts a latent state of the scripted performance represented by a node in the directed graph corresponding to the current temporal location within the live execution of the scripted performance.

Machine learning model 250 calculates pairwise metrics that each describe a degree of similarity between features included in monitor input 210 and the description associated with a node included in the directed graph. In various embodiments, machine learning model 250 may include a cross-modal foundational model, such as CLIP. A cross-modal foundational model is operable to directly calculate a degree of similarity between a textual description and one or more features included in monitor input 210, such as features associated with an audio signal or a video signal. Additionally or alternatively, machine learning model 250 may include a trained Large Multimodal Model (LMM) or Multimodal Large Language Model (MLLM) that is also operable to calculate a degree of similarity across input modalities.

In various embodiments, machine learning model 250 may divide monitor input 210 into T time frames and generate multimodal features F₁ . . . F_{T} for the T time frames. Machine learning model 250 may also analyze node features N₁ . . . N_{K} associated with K nodes included in the directed graph received from graph generation module 240. The node features N₁ . . . N_{K} may be based on the semantic descriptions received from semantic description generator 230. Machine learning model 250 generates a conditional probability for a latent state Zₜ associated with a time frame t being in node Nₖ of the K nodes, i.e., Prob (Zₜ=Nₖ|F₁ . . . Fₜ).

In various embodiments, machine learning model 250 may employ speech-to-text, object recognition, and/or video annotation techniques to generate textual descriptions based on the contents of monitor input 210. Machine learning model 250 may then calculate a similarity metric based on a text-to-text comparison of the textual descriptions associated with monitor input 210 and the textual segment descriptions received from semantic description generator 230.

In other embodiments, machine learning model 250 may include a fact-checking LLM, such as an entailment model. An entailment model proposes a current latent state of the live performance represented by a node in the directed graph, and then generates a confidence value indicating to what extent the proposal is supported by the textual description associated with the node and the contents of monitor input 210. In various embodiments, the entailment model may generate or obtain a textual description of monitor input 210 and generate the confidence value based on how well the proposed latent state is supported by the textual description of monitor input 210. Alternatively or additionally, the entailment model may include a multimodal entailment model operable to generate the confidence value based on the textual description associated with the proposed node and one or more visual images or video sequences included in monitor input 210.

Machine learning model 250 predicts a current latent state of the live performance based on the calculated similarity metrics and/or confidence values associated with nodes included in the directed graph. Machine learning model 250 may modify one or more similarity metrics and/or confidence values based on the directed graph and previously predicted latent states. For example, given a directed graph including a node representing a previously predicted segment or beat, machine learning model 250 may limit its prediction of the current latent state of the live performance to those nodes that are directly reachable from the node associated with the previously predicted segment or beat. Likewise, in a directed graph that includes multiple parallel, mutually exclusive paths through the graph, machine learning model 250 may determine from one or more previously predicted latent states that the live performance is proceeding along a particular one of the multiple mutually exclusive paths. Machine learning model 250 may modify one or more pairwise similarity metrics and/or confidence values to favor a next predicted latent state that lies along the current path over one or more other latent states that do not lie on the current path. Machine learning model generates latent state prediction 260 based on the (potentially modified) similarity metrics and/or confidence values.

Latent state prediction 260 includes a node within the directed graph corresponding to a segment or beat of the scripted performance identified by segment extractor 220. Latent state prediction 260 represents an alignment between performance plan 200 describing a scripted performance and the current temporal location within the live execution of the scripted performance described by monitor input 210. Alignment engine 122 transmits latent state prediction 260 to one or more downstream applications 270. Alignment engine 122 may also store a history of latent state predictions 260 in, e.g., storage 114 for later retrieval and/or analysis.

Downstream application 270 may perform one or more actions and/or provide one or more functionalities or analyses based on latent state prediction 260. For example, based on a segment or beat associated with latent state prediction 260, one of downstream applications 270 may automatically initiate a visual effect, sound effect or lighting effect. As another example, one of downstream applications 270 may automatically initiate the execution of an animatronic or robotic action based on the currently predicted segment or beat associated with latent state prediction 260. For instance, if a video signal included in monitor input 210 depicts one or more audience members congregating in the vicinity of a robotic or animatronic character, the downstream application 270 may initiate a movement or other performance (e.g., a visual effect, a sound effect, a lighting effect, or speech) by the robotic or animatronic character.

One of downstream applications 270 may also modify the presentation of a user-operated control board, such as a video or audio control board, based on latent state prediction 260. For example, the downstream application 270 may highlight or otherwise emphasize one or more controls included in a control board that are most relevant to the current predicted segment or beat, while dimming or deactivating less-relevant controls. By modifying the presentation of the control board, the downstream application 270 may simplify the operation of the control board for the user.

One of downstream applications 270 may include an offline context-aware viewing companion application. For a previously recorded linear scripted performance, such as a film, a context-aware viewing companion application is operable to answer questions about the scripted performance based on the predicted current latent state of the recorded performance, as well as previous segments or beats included in the recorded performance. For example, a user could query the viewing companion application with a prompt, such as “Tell me about the character ‘Bob’.” In response, the viewing companion application may display, verbally recite, or otherwise present a summary of, e.g., the character's background, dialog, actions, and character development based on textual descriptions of the current and previous segments or beats included in the scripted performance. Because the responses may be based on the current and previous segments or beats, the viewing companion application may provide contextual, spoiler-free responses to user queries. The viewing companion application may also navigate to a specific segment or beat included in the scripted performance based on a descriptive user query, such as “go to the dancing scene with Bob and Alice.” Such navigation actions may not necessarily be limited to previously viewed segments or beats.

One of downstream applications 270 may provide an online or offline analysis based on how closely a live or recorded execution of the scripted performance adheres or adhered to performance plan 200. In various embodiments, the downstream application 270 may identify skipped segments or beats based on consecutive values of latent state prediction 260 and the structure of the directed graph produced by graph generation module 240. For example, if the directed graph depicts that a segment “A” should be followed by segment “B,” and that segment “B” should be followed by segment “C,” consecutive values of “A” and “C” for latent state prediction 260 may indicate that the live or recorded execution of the scripted performance has skipped segment “B.” Another downstream application 270 may compare the similarity scores obtained along the path on the directed graph given by the latent state prediction 260 by machine learning model 250 as a metric describing how closely an execution of a scripted performance followed a plan, or to compare against a predetermined threshold to provide feedback to the show creators, directors, producers, or actors.

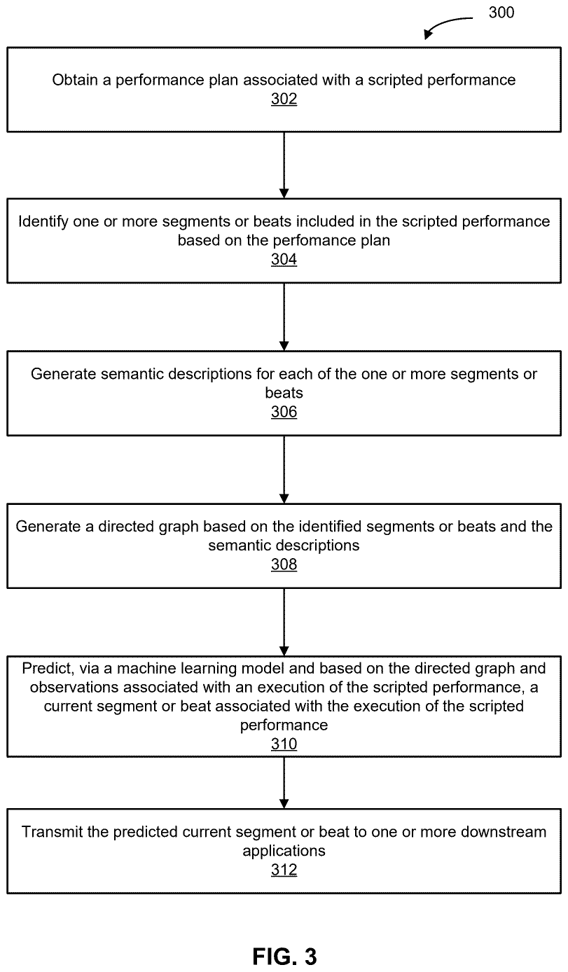

FIG. 3 is a flow diagram of method steps for performing multimodal alignment of a plan to the execution of a live performance, according to some embodiments. Although the method steps are described in conjunction with the systems of FIGS. 1-2, persons skilled in the art will understand that any system configured to perform the method steps in any order falls within the scope of the present disclosure.

As shown, in step 302 of method 300, alignment engine 122 obtains performance plan 200 associated with a scripted performance. Performance plan 200 includes one or more descriptive documents associated with a scripted performance. The descriptive documents may include, but are not limited to, a script, a synopsis, or a cue sheet. A script may include one or more of character dialogue, scenery, location, or environment descriptions, stage directions, descriptions of character actions, descriptions of potential audience reactions, or descriptions of sound and/or visual effects. A synopsis may include a description of the scripted work, including characters, storyline, main plot points, character development, tone, genre, theme, or settings. A cue sheet may include a listing of cues within a scripted performance, such as spoken lines or character actions. Each cue may be associated with a corresponding action, such as a character action or reaction, a change in lighting, a sound effect, a visual effect, or an animatronic or robotic action.

In step 304, segment extractor 220 of alignment engine 122 identifies one or more beats or segments included in the scripted performance, based on the performance plan. In various embodiments, a segment or beat refers to a change from one scene to another, or to a change within a scene based on, for example, lighting, action, dialogue, or sound events included in the scene. Segments or beats may include a reaction by an actor, a change in trajectory associated with a character's storyline, a change in tone or mood within a scene, or a change in the topic of a conversation. Segment extractor 220 may include a trained machine learning model that performs a semantic analysis of one or more elements included in performance plan 200 and identifies individual segments or beats associated with the scripted performance. In various embodiments, the one or more elements included in performance plan 200 may include a script, a synopsis, and/or a cue sheet. Segment extractor 220 may associate portions of one or more elements included in performance plan 200 with each of the identified segments or beats. For example, segment extractor 220 may associate a portion of the script, a portion of the synopsis, and one or more entries included in the cue sheet with an identified segment or beat. Segment extractor 220 transmits the identified segments/beats and the associated portions of performance plan 200 to semantic description generator 230.

In step 306, semantic description generator 230 of alignment engine 122 generates semantic descriptions for each of the one or more segments or beats. Semantic description generator 230 analyzes the portions of performance plan 200 associated with the segments or beats received from segment extractor 220 and generates, for each segment or beat, a textual description associated with the segment or beat. In various embodiments, semantic description generator 230 may include a trained machine learning model that generates a plain language summary or other description associated with a segment or beat, based on the portions of performance plan 200 associated with the segment or beat. A plain language summary may include scene descriptions, character dialogue or actions included in a script, plot points or character development points included in a synopsis, and/or cues included in a cue sheet describing sound, visual, animatronic, robotic, lighting, or other effects.

In step 308, graph generation module 240 of alignment engine 122 produces a directed graph based on the identified segments or beats and the generated semantic descriptions. The directed graph includes one or more nodes and one or more edges, where each node is associated with a single segment or beat and each edge represents a potential transition from one node to another node, or from one node to itself. Graph generation module 240 determines the structure of the nodes and edges based on the beats and segments identified by segment extractor 220, the descriptions received from semantic description generator 230, and the elements included in performance plan 200. Each node included in the directed graph represents a latent state of the scripted performance associated with a single segment or beat, and includes a semantic description associated with the segment or beat. The directed graph represents a machine-readable expression of the structure of the scripted performance, including potential paths through the scripted performance from one latent state to another.

In step 310, machine learning model 250 of alignment engine 122 predicts a current segment or beat associated with a live execution of the scripted performance. Machine learning model 250 includes one or more trained machine learning models that compare features included in monitor input 210 with textual descriptions associated with nodes included in the directed graph received from graph generation module 240. Based on the comparison, machine learning model 250 predicts a latent state of the scripted performance represented by a node in the directed graph corresponding to the current temporal location within the live execution of the scripted performance.

Machine learning model 250 calculates pairwise metrics that each describe a degree of similarity between features included in monitor input 210 and the description associated with a node included in the directed graph. In various embodiments, machine learning model 250 may include a cross-modal foundational model, such as CLIP. A cross-modal foundational model is operable to directly calculate a degree of similarity between a textual description and one or more features included in monitor input 210, such as features associated with an audio signal or a video signal.

In various embodiments, machine learning model 250 may employ speech-to-text, object recognition, and/or audiovisual annotation techniques to generate textual descriptions based on the contents of monitor input 210. Machine learning model 250 may then calculate a similarity metric based on a text-to-text comparison of the textual descriptions associated with monitor input 210 and the textual segment descriptions received from semantic description generator 230.

In other embodiments, machine learning model 250 may include a fact-checking LLM, such as an entailment model. An entailment model proposes a current latent state of the live performance represented by a node in the directed graph, and then generates a confidence value indicating to what extent the proposal is supported by the textual description associated with the node and the contents of monitor input 210. In various embodiments, the entailment model may generate or obtain a textual description of monitor input 210 and generate the confidence value based on how well the proposed latent state is supported by the textual description of monitor input 210. Alternatively or additionally, the entailment model may include a multimodal entailment model operable to generate the confidence value based on the textual description of the proposed node and one or more visual images or video sequences included in monitor input 210.

Machine learning model 250 predicts a current latent state of the live performance based on the calculated similarity metrics and/or confidence values associated with nodes included in the directed graph. Machine learning model 250 may modify one or more similarity metrics and/or confidence values based on the directed graph and previously predicted latent states. For example, given a directed graph including a node representing a previously predicted segment or beat, machine learning model 250 may increase similarity metrics and/or confidence values associated with nodes that are directly reachable from the node associated with the previously predicted segment or beat. Likewise, in a directed graph that includes multiple parallel, mutually exclusive paths through the graph, machine learning model 250 may determine from one or more previously predicted latent states that the live performance is proceeding along a particular one of the multiple mutually exclusive paths. Machine learning model 250 may modify one or more pairwise similarity metrics and/or confidence values to favor a next predicted latent state that lies along the current path over one or more other latent states that do not lie on the current path. Machine learning model generates latent state prediction 260 based on the (potentially modified) similarity metrics and/or confidence values.

In step 312, alignment engine 122 transmits latent state prediction 260 to one or more downstream applications 270. Downstream application 270 may perform one or more actions and/or provide one or more functionalities or analyses based on latent state prediction 260. For example, based on a segment or beat associated with latent state prediction 260, one of downstream applications 270 may automatically initiate a visual effect, sound effect or lighting effect. One of downstream applications 270 may automatically initiate the execution of an animatronic or robotic action based on the currently predicted segment or beat associated with latent state prediction 260. For instance, if a video signal included in monitor input 210 depicts one or more audience members congregating in the vicinity of a robotic or animatronic character, the downstream application 270 may initiate a movement or other performance by the robotic or animatronic character.

One of downstream applications 270 may also modify the operation of a user-operated control board, such as a video or audio control board, based on latent state prediction 260. For example, the downstream application 270 may highlight or otherwise emphasize one or more controls on a control board that are most relevant to the current predicted segment or beat, while dimming or deactivating less-relevant controls.

One of downstream applications 270 may include an offline context-aware viewing companion application. For a previously recorded linear scripted performance, such as a film, a context-aware viewing companion application is operable to answer questions about the scripted performance based on the predicted current latent state of the recorded performance, as well as previous segments or beats included in the recorded performance. Because the responses may be based on the current and previous segments or beats, the viewing companion application may provide contextual, spoiler-free responses to user queries. The viewing companion application may also navigate to a specific segment or beat included in the scripted performance based on a descriptive user query, such as “go to the fight scene between Bob and Alice.” Such navigation actions may not necessarily be limited to previously viewed segments or beats.

One of downstream applications 270 may provide an online or offline analysis based on how closely a live or recorded execution of the scripted performance adheres or adhered to performance plan 200. In various embodiments, the downstream application 270 may identify skipped segments or beats based on consecutive values of latent state prediction 260 and the structure of the directed graph produced by graph generation module 240. For example, if the directed graph depicts that a segment “A” should be followed by segment “B,” and that segment “B” should be followed by segment “C,” consecutive values of “A” and “C” for latent state prediction 260 may indicate that the live or recorded execution of the scripted performance has skipped segment “B.” Another downstream application 270 may compare the similarity scores obtained along the path on the directed graph given by the latent state prediction 260 by machine learning model 250 as a metric describing how closely an execution of a scripted performance followed a plan, or to compare against a predetermined threshold to provide feedback to the show creators.

In sum, the disclosed techniques align segments of a performance extracted from a script, synopsis, or other high-level description of the performance to timestamps associated with a live execution of the performance. The alignment may be based on multimodal input associated with the high-level description and the live execution, such as audio, visual, or text inputs. Based on the alignment, the techniques may monitor the live execution of the performance and determine a specific segment of the performance associated with the current state of the live execution. In an online mode of operation, the techniques may also trigger one or more actions, such as sound effects, visual effects, lighting effects, or animatronic actions based on cues extracted from the script, synopsis, or other high-level description of the performance. In an offline postprocessing mode, the techniques may determine how faithfully the live execution of the performance followed the segments extracted from the high-level description.

In operation, an alignment engine receives a plan associated with a live performance, such as a film shoot, stage performance, parade, or character meet-and-greet event. The plan may include one or more of a script, synopsis, or cue sheet associated with the live performance. The alignment engine performs a semantic analysis of the plan and divides the performance into multiple segments or beats based on the plan. A segment or beat refers to a change from one scene to another, or to a change within a scene based, for example, on lighting, action, dialogue, or sound included in the scene. Segments or beats may include, but are not limited to, a reaction by an actor, a change in trajectory associated with a character's storyline, a change in tone or mood within a scene, or a change in the topic of a conversation. Some scripted performances may proceed in a linear fashion from one beat to the next, without skipping or repeating any beats. Other scripted performances may include potential deviations based on, for example, character improvisation or audience interaction. Such deviations may include loops of one or more repeating beats, or parallel branches within the scripted performance each including one or more beats.

The alignment engine may express the segments or beats extracted from the plan as a collection of latent states, with each latent state corresponding to a single segment or beat. The alignment engine may further express the scripted performance as a directed graph based on the plan associated with the scripted performance, where each node included in the directed graph represents a different latent state and each edge included in the directed graph represents a transition from one latent state to another. The directed graph may also include designated starting and ending nodes, as well as self-referential directed edges leading from a latent state to the same latent state. The alignment engine may also generate a semantic description associated with each latent state, based on the plan associated with the scripted performance.

The alignment engine also receives multimodal input associated with a live execution of the scripted performance. The multimodal input may include audio and/or video observations associated with the live execution. The audio and/or video observations may include observations of one or more of actors, an audience, or an environment associated with the live execution. In performances that include Virtual Reality/Augmented Reality (AR/VR) elements, the audio and/or video observations may also include egocentric audio and/or video observations from the point of view of, for example, an audience member wearing an AR/VR headset.

The alignment engine includes one or more machine learning models that predict a latent state associated with the scripted performance that corresponds to the received multimodal input at a particular time, based on similarities between the received multimodal inputs and semantic descriptions associated with one or more latent states. The one or more machine learning models may include cross-modal foundational models, Large Multimodal Models (LMMs), Multimodal Large Language Models (MLLMs) text-based similarity models, and/or fact-checking entailment models.

The one or more machine learning models generate pairwise similarity values between features included in the received multimodal input at a particular time and each of the nodes included in the directed graph. The alignment engine generates a probability distribution over the collection of possible latent states in the directed graph, based on heuristic constraints on the structure of the scripted performance, such as edges included in the directed graph. Based on the probability distribution, the alignment engine predicts a current latent state representing a segment or beat included in the scripted performance.

The alignment engine may transmit the predicted current segment or beat to one or more downstream applications. These downstream automations may trigger one or more actions based on the predicted current segment or beat and the plan associated with the scripted performance. For example, a downstream application may trigger a visual effect, a sound effect, a lighting effect, or an animatronic or other robotic action. A downstream application may modify the operation of one more operator-controlled interfaces associated with the performance, such as a lighting control board, an audio control board, or an animation control board. For example, the downstream application may tailor the control options presented to the operator via the interface based on the current segment or beat, such as highlighting some control options while de-emphasizing or hiding other options.

As another example, a downstream application may analyze how closely the live execution of a performance follows or followed a plan associated with the performance. The analyze may be performed in real time during the performance, or as a post-performance process based on a recording of the performance. The analysis may include a determination of missed segments or beats, unexpected repetitions of segments or beats, and/or an analysis of particular loops or parallel branches executed during the performance.

One technical advantage of the disclosed techniques relative to the prior art is that the disclosed techniques are operable to automatically monitor a scripted performance based on a human-interpretable script or other plan and multimodal input describing the performance. The disclosed techniques may also prompt the automatic execution of one or more automations or other actions based on a predicted state of the performance relative to the script or other plan. These technical advantages provide one or more improvements over prior art approaches.
1. In some embodiments, a computer-implemented method for aligning a performance plan to an execution of a scripted performance, the computer-implemented method comprises receiving a performance plan, wherein the performance plan includes one or more documents associated with a scripted performance, identifying, via a first machine learning model and based on the one or more documents, one or more segments included in the scripted performance, predicting, via a second machine learning model, a current segment of the one or more segments based at least on one or more observation signals associated with the execution of the scripted performance, and initiating an execution of one or more automated actions based on the predicted current segment.
2. The computer-implemented method of clause 1, wherein the documents associated with the scripted performance include one or more of a script, a synopsis, or a cue sheet.
3. The computer-implemented method of clauses 1 or 2, further comprising generating, via a pre-trained machine learning model, a textual description associated with a segment included in the one or more segments.
4. The computer-implemented method of any of clauses 1-3, wherein predicting the current segment of the one or more segments further includes calculating, via a cross-modal foundational model, a similarity metric based on the one or more observation signals and the textual description associated with the segment included in the one or more segments.
5. The computer-implemented method of any of clauses 1-4, wherein predicting the current segment of the one or more segments further includes generating textual descriptions associated with the one or more observation signals and calculating a similarity metric based on a text-to-text comparison of the textual descriptions associated with the observation signals and the textual description associated with the segment included in the one or more segments.
6. The computer-implemented method of any of clauses 1-5, wherein the one or more observation signals associated with the execution of the scripted performance include one or more of (i) an audio feed, (ii) a video feed, or (iii) location or behavior information associated with a robotic or animatronic character.
7. The computer-implemented method of any of clauses 1-6, further comprising generating, based on the one or more identified segments, a directed graph including one or more nodes and one or more edges, wherein each node is associated with a single segment included in the scripted performance and each edge represents a potential transition from one node to another node, or from one node to itself.
8. The computer-implemented method of any of clauses 1-7, wherein the one or more automated actions include modifying a presentation of one or more controls included in a user-operated control board based on the identified current segment.
9. The computer-implemented method of any of clauses 1-8, wherein the one or more automated actions include initiating one or more of a visual effect, a sound effect, a lighting effect, or a robotic or animatronic performance based on the identified current segment.
10.In some embodiments, one or more non-transitory computer-readable media store instructions that, when executed by one or more processors, cause the one or more processors to perform the steps of receiving a performance plan, wherein the performance plan includes one or more documents associated with a scripted performance, identifying, via a first machine learning model and based on the one or more documents, one or more segments included in the scripted performance, predicting, via a second machine learning model, a current segment of the one or more segments based at least on one or more observation signals associated with the execution of the scripted performance, and initiating an execution of one or more automated actions based on the predicted current segment.
11.The one or more non-transitory computer-readable media of clause 10, wherein the documents associated with the scripted performance include one or more of a script, a synopsis, or a cue sheet.
12.The one or more non-transitory computer-readable media of clauses 10 or 11, wherein the instructions further cause the one or more processors to perform the step of generating, via a pre-trained machine learning model, a textual description associated with a segment included in the one or more segments.
13.The one or more non-transitory computer-readable media of any of clauses 10-12, wherein predicting the current segment of the one or more segments further includes calculating, via a cross-modal foundational model, a similarity metric based on the one or more observation signals and the textual description associated with the segment included in the one or more segments.
14.The one or more non-transitory computer-readable media of any of clauses 10-13, wherein predicting the current segment of the one or more segments further includes generating textual descriptions associated with the one or more observation signals and calculating a similarity metric based on a text-to-text comparison of the textual descriptions associated with the observation signals and the textual description associated with the segment included in the one or more segments.
15.The one or more non-transitory computer-readable media of any of clauses 10-14, wherein the one or more observation signals associated with the execution of the scripted performance include one or more of (i) an audio feed, (ii) a video feed, or (iii) location or behavior information associated with a robotic or animatronic character.
16.The one or more non-transitory computer-readable media of any of clauses 10-15, wherein the instructions further cause the one or more processors to perform the step of generating, based on the one or more identified segments, a directed graph including one or more nodes and one or more edges, wherein each node is associated with a single segment included in the scripted performance and each edge represents a potential transition from one node to another node, or from one node to itself.
17.The one or more non-transitory computer-readable media of any of clauses 10-16, wherein the one or more automated actions include modifying a presentation of one or more controls included in a user-operated control board based on the identified current segment.
18.The one or more non-transitory computer-readable media of any of clauses 10-17, wherein the one or more automated actions include initiating one or more of a visual effect, a sound effect, a lighting effect, or a robotic or animatronic performance based on the identified current segment.
19.In some embodiments, a system comprises one or more memories storing instructions, and one or more processors for executing the instructions to receive a performance plan, wherein the performance plan includes one or more documents associated with a scripted performance, identify, via a first machine learning model and based on the one or more documents, one or more segments included in the scripted performance, predict, via a second machine learning model, a current segment of the one or more segments based at least on one or more observation signals associated with the execution of the scripted performance, and initiate an execution of one or more automated actions based on the predicted current segment.
20.The system of clause 19, wherein the one or more processors further execute the instructions to generate, based on the one or more identified segments, a directed graph including one or more nodes and one or more edges, wherein each node is associated with a single segment included in the scripted performance and each edge represents a potential transition from one node to another node, or from one node to itself.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for aligning a performance plan to an execution of a scripted performance, the computer-implemented method comprising:
receiving a performance plan, wherein the performance plan includes one or more documents associated with a scripted performance;
identifying, via a first machine learning model and based on the one or more documents, one or more segments included in the scripted performance;
predicting, via a second machine learning model, a current segment of the one or more segments based at least on one or more observation signals associated with the execution of the scripted performance; and
initiating an execution of one or more automated actions based on the predicted current segment.

2. The computer-implemented method of claim 1, wherein the documents associated with the scripted performance include one or more of a script, a synopsis, or a cue sheet.

3. The computer-implemented method of claim 1, further comprising generating, via a pre-trained machine learning model, a textual description associated with a segment included in the one or more segments.

4. The computer-implemented method of claim 3, wherein predicting the current segment of the one or more segments further includes calculating, via a cross-modal foundational model, a similarity metric based on the one or more observation signals and the textual description associated with the segment included in the one or more segments.

5. The computer-implemented method of claim 3, wherein predicting the current segment of the one or more segments further includes generating textual descriptions associated with the one or more observation signals and calculating a similarity metric based on a text-to-text comparison of the textual descriptions associated with the observation signals and the textual description associated with the segment included in the one or more segments.

6. The computer-implemented method of claim 1, wherein the one or more observation signals associated with the execution of the scripted performance include one or more of (i) an audio feed, (ii) a video feed, or (iii) location or behavior information associated with a robotic or animatronic character.

7. The computer-implemented method of claim 1, further comprising generating, based on the one or more identified segments, a directed graph including one or more nodes and one or more edges, wherein each node is associated with a single segment included in the scripted performance and each edge represents a potential transition from one node to another node, or from one node to itself.

8. The computer-implemented method of claim 1, wherein the one or more automated actions include modifying a presentation of one or more controls included in a user-operated control board based on the identified current segment.

9. The computer-implemented method of claim 1, wherein the one or more automated actions include initiating one or more of a visual effect, a sound effect, a lighting effect, or a robotic or animatronic performance based on the identified current segment.

10. One or more non-transitory computer-readable media storing instructions that, when executed by one or more processors, cause the one or more processors to perform the steps of:
receiving a performance plan, wherein the performance plan includes one or more documents associated with a scripted performance;
identifying, via a first machine learning model and based on the one or more documents, one or more segments included in the scripted performance;
predicting, via a second machine learning model, a current segment of the one or more segments based at least on one or more observation signals associated with the execution of the scripted performance; and
initiating an execution of one or more automated actions based on the predicted current segment.

11. The one or more non-transitory computer-readable media of claim 10, wherein the documents associated with the scripted performance include one or more of a script, a synopsis, or a cue sheet.

12. The one or more non-transitory computer-readable media of claim 10, wherein the instructions further cause the one or more processors to perform the step of generating, via a pre-trained machine learning model, a textual description associated with a segment included in the one or more segments.

13. The one or more non-transitory computer-readable media of claim 12, wherein predicting the current segment of the one or more segments further includes calculating, via a cross-modal foundational model, a similarity metric based on the one or more observation signals and the textual description associated with the segment included in the one or more segments.

14. The one or more non-transitory computer-readable media of claim 12, wherein predicting the current segment of the one or more segments further includes generating textual descriptions associated with the one or more observation signals and calculating a similarity metric based on a text-to-text comparison of the textual descriptions associated with the observation signals and the textual description associated with the segment included in the one or more segments.

15. The one or more non-transitory computer-readable media of claim 10, wherein the one or more observation signals associated with the execution of the scripted performance include one or more of (i) an audio feed, (ii) a video feed, or (iii) location or behavior information associated with a robotic or animatronic character.

16. The one or more non-transitory computer-readable media of claim 10, wherein the instructions further cause the one or more processors to perform the step of generating, based on the one or more identified segments, a directed graph including one or more nodes and one or more edges, wherein each node is associated with a single segment included in the scripted performance and each edge represents a potential transition from one node to another node, or from one node to itself.

17. The one or more non-transitory computer-readable media of claim 10, wherein the one or more automated actions include modifying a presentation of one or more controls included in a user-operated control board based on the identified current segment.

18. The one or more non-transitory computer-readable media of claim 10, wherein the one or more automated actions include initiating one or more of a visual effect, a sound effect, a lighting effect, or a robotic or animatronic performance based on the identified current segment.

19. A system comprising:
one or more memories storing instructions; and
one or more processors for executing the instructions to:
receive a performance plan, wherein the performance plan includes one or more documents associated with a scripted performance;
identify, via a first machine learning model and based on the one or more documents, one or more segments included in the scripted performance;
predict, via a second machine learning model, a current segment of the one or more segments based at least on one or more observation signals associated with the execution of the scripted performance; and
initiate an execution of one or more automated actions based on the predicted current segment.

20. The system of claim 19, wherein the one or more processors further execute the instructions to generate, based on the one or more identified segments, a directed graph including one or more nodes and one or more edges, wherein each node is associated with a single segment included in the scripted performance and each edge represents a potential transition from one node to another node, or from one node to itself.
